(19) United States
(12) Patent Application Publication
(10) Pub. No.: US 2002/0118196 A1
(43) Pub. Date: Aug. 29, 2002

(54) Audio and video synthesis method and system

(75) Inventor: Adrian Ian Skilling, Malvern (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: 20/20 Speech Limited, London (GB)

(21) Appl. No.: 10/006,120

(22) Filed: Dec. 10, 2001

(30) Foreign Application Priority Data
Dec. 11, 2000 (GB) GB 0030148.1

(51) Int. Cl. G06T 13/00

(52) U.S. Cl. 345/473

(57) ABSTRACT

A method and system for synthesising a moving image, most particularly in synchronism with synthesised audio output, is disclosed. A configuration of a feature (e.g. a facial feature) in an image is defined by one or more parameters and the progress of transition of one value of a parameter to another is controlled by one or more predefined rules. The parameters for the audio and the video output are generated by respective transition tables from a source of sub-phonetic segment descriptors. The audio parameter transition table may be constructed in accordance with HMS principles. The video parameter transition table may be similarly constructed. The respective parameters are processed an audio engine and a video engine to generate an audio and an animated video output. A typical application is to produce a so-called talking head that might be used as a virtual television presenter.

### BACKGROUND OF THE INVENTION

The present invention relates to an audio and video synthesis system.

Developments in synthesis of audio and video content have come together to produce avatars; entirely synthesised representations of a speaking person (or a person's face) that can, for example, serve as a virtual presenter for a video production. For an avatar to make a satisfactory impression upon its audience, it is, of course, necessary for the quality of the visual image and the synthesised speech to be of a good standard. Moreover, it is also highly desirable that the visual image presented to the user, and most particularly, the movement of the representation of the mouth, should be realistic and should correspond to and synchronise with the synthesised speech. It is recognised that people are very sensitive to inaccuracies in the correspondence between a speaker's facial movements and the sound of their speech and that even small discrepancies will be noticeable.

### SUMMARY OF THE PRIOR ART

One approach to creating a synthesised image, particularly of a human head or face, is to create a library of video clips that show parts of the face in a large range of positions. Such an approach is disclosed in, for example, EP-A-0 883 090, U.S. Pat. Nos. 6,112,177, 6, 097,381 and 5,878,396. A disadvantage faced by those implementing such systems is that the image library requires a large amount of storage memory and lacks flexibility since for each face to be reproduced the image library must be re-created.

### BRIEF SUMMARY OF THE INVENTION

An aim of this invention is to provide an audio and video synthesis system that provides a video image that represents a speaker and synthesised speech in which the image presented has an appearance suggestive that it is the source of the speech. For example, the speaker may represent a human speaker and may be arranged to have a lifelike appearance.

It is recognised that synthesised speech will sound true-to-life only when the limitations of vocal production anatomy are taken into account. This means that human speech is not composed of individual phones each having a distinct start and a distinct end. Rather, there is a period of transition between each phone that occurs as the speaker's mouth, tongue, and all other parts of their vocal anatomy move form one configuration to the next. As with any physical system, there is a limit to the speed with which such configurations can be adopted, with the result that the accuracy with which each phone is produced decreases as the speed of speech increases.

These limitations are inherent in human speech but they have to be incorporated by design into synthesised speech if that speech is to sound true-to-life. Without these limitations, it may be possible to produce very rapid synthesised speech that is comprehensible and close to a theoretically ideal model, but it will not sound lifelike.

One table-driven system for designing physiological limitations into the output of a speech synthesiser is known as the Holmes-Mattingly-Shearme (HMS) system. This system defines transitions between configurations of the human vocal system that are defined by numerical parameters. In order that the number of transitions that must be defined is not excessively large, the system primarily defines transitions between consonants, which, it has been found, have an influence that predominates the effect of vowels.

The present invention arises from the realisation that the physiological limitations that affect human speech also affect the appearance of a human speaker. For example, the speed at which a human speaker can move their lips limits the speed at which they can change the sound that they are producing; if a synthesised image of a speaker's lips and facial features can be limited to take this into account, the synthesised image may have a more satisfactory appearance than might otherwise be the case.

In the light of this realisation, the invention provides, from a first aspect, a method of synthesising a moving image in which a configuration of a feature in an image is defined by one or more parameters and the progress of transition of one value of a parameter to another is controlled by one or more predefined rules, in which the value of each parameter defines the instantaneous position of a particular physical entity represented in the synthesised image.

A method embodying this invention can therefore produce a visual display that can be configured to exhibit movement with characteristics that are in accordance with a predefined model. For example, the model may be designed to approximate human physiology.

This invention has particularly advantageous application to synthesis of a display that will be associated with synthesised audio output. As one example, the invention provides a method of generating a visual display that changes in synchronism with synthesised vocal output to give an impression that the vocal output is being produced by an object illustrated in the display. The vocal output might typically include (or be) speech, or might alternatively or additionally include song and/or other vocal utterances.

A particular example of a method embodying the last-preceding paragraph lies in the generation of display representative of a human head and simulated human vocal output, wherein the display changes to represent movements a human (or at least a human head or face) that is producing the vocal output. Such a display is commonly referred to as a “talking head” or an “avatar”. However, the method has equal application to generating an image that is abstract, or of an object not normally capable of vocalisation. Such a display can be used to generate anthropomorphic output, for example, for an animated cartoon.

In embodiments according to the last-preceding paragraph, a first set of segments may be processed to generate facial movements arising from speech (typically, lip movements) and a further set of segments is processed to generate other facial movements (such as movement of the whole head, eye-blinking and so forth). The first set of segments may be those processed to generate an audio output.

Advantageously, the method uses a set of data to define synthesised audio signals and a set of data to define synthesised video signals. There may be a respective data set for each of the audio and the video signals, or, in alternative embodiments, the audio and the video signals may be defined by a common set of data. Such a data set may, for example, define a sequence of segment descriptors, each segment descriptor identifying a data value of a segment. Typically, each segment represents the state of a corresponding physical entity. For example, in speech synthesis, one or more such segments defines each vocal phone in the synthesised speech. In visual synthesis, one or more such segments describes the position of a visual element in a video signal.

A method embodying the invention most normally includes a step of translating segment descriptors into parameters that define an audio output and a step of translating segment descriptors into parameters that define a video output. In each case, the translating step includes a definition of the change of one parameter value to another. Translating the segments to generate parameters to define the audio output may proceed in accordance with HMS rules. In each case, translation of the segments into parameters may include generation of a parameter track that defines how the parameter changes with time. Most typically, each of the video and the audio output is represented by a plurality of parameters.

The path that any parameter follows from segment to segment is dependent upon the physical entity that the parameter represents. For example, a parameter representing the position of a jaw in an image may be constrained to change more slowly than a parameter representing the position of a tongue. Moreover, the path may be dominated by either its starting value or its target value, if one or other of these has a greater influence upon the physical configuration of the physical entity. For example, a parameter representing lip position will be heavily dominated by a value representative of a ‘b’ or ‘p’ sound, since human speech demands that the lips actually reach a particular configuration to make such a sound. In this respect, each of the parameters is independent from the other parameters.

A method embodying the invention may further include a step of creating an image as defined by the parameters. The image may be rendered as a solid 3-D image. The created image may be entirely synthetic; that is to say, it may be generated using rules as a function of the parameters, rather than being derived from a captured video image. Such an image can readily be generated using suitable image generation software, for example, as used in computer animation.

To create the appearance of a moving image, a method embodying the invention may include creation of a plurality of images from a stream of segment descriptors extending over a time extent, and displaying the plurality of images in succession to create an animated display. In such embodiments, audio output may be generated in synchronism with the animated display. The audio output may include, for example synthesised vocalisation that can be derived from the stream of segment descriptors.

Each parameter in embodiments of the invention most typically has a minimal and a maximal value that define respective first and second extreme positions for vertices in the said feature in an image. For example, the minimum value may be 0 and the maximal value may be 1. In response to parameter values intermediate the minimal and maximal values, an image is typically generated with vertices in positions intermediate the first and second extreme positions. These vertices may be in positions calculated by linear interpolation based upon the value of the parameter.

From a second aspect, the invention provides a video image synthesis system comprising an input stage for receiving a stream of data that defines a sequence of segment descriptors, a first translation stage for translating the segment descriptors into a plurality of parameter tracks for controlling a video output and a plurality of parameter tracks for controlling an audio output.

A system embodying the invention typically further includes display means for receiving parameters and generating a display defined by the parameters. More specifically, the display means may be operative to generate an animated display in response to changes in the parameters with time.

In addition, a system embodying the invention further comprises audio reproduction means for receiving parameters and generating an audio output defined by the parameters. Such audio reproduction means may be operative to generate what may be perceived as a continuous audio output in response to changes in the parameters with time.

Many embodiments of this aspect of the invention include an audio-visual reproduction stage operative to receive a plurality of time-varying parameters and to generate an animated video display and a continuous audio output defined by the received parameters.

Each translation stage may include a translation table and is operative to generate a parameter track by reference to the translation table. Such a translation table may include a target value for each parameter to be achieved for each descriptor segment. It may also include a rank for each segment descriptor. In such embodiments, at a transition between two segments, the segment that has a higher rank predominates in defining the track followed by parameters during the transition between the segments.

### BRIEF DESCRIPTION OF THE DRAWINGS

FIG. 1 is a diagrammatical representation of the transition between two phones in continuous human speech;

FIG. 2 is a block diagram of a system embodying the invention;

FIG. 3 is an example of an image generated with a first parameter at a normal value; and

FIG. 4 is an example of an image generated with a first parameter at a maximal value.

### DETAILED DESCRIPTION OF THE INVENTION

An embodiment of the invention will now be described in detail by way of example, and with reference to the accompanying drawings.

In order that the operating principles behind this embodiment can be more clearly understood, the HMS principles will now be described briefly, as they can be applied to production of audio output and how they may be adapted to generate video output.

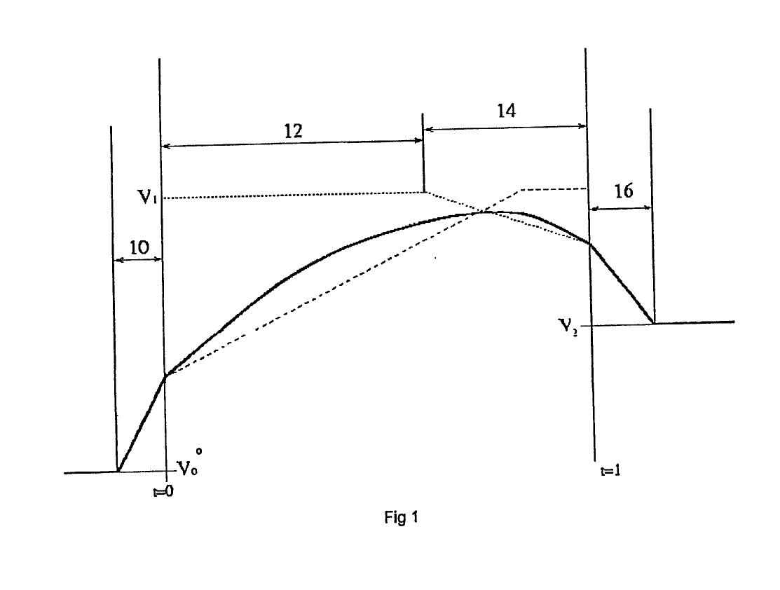

With reference first to FIG. 1, the vertical axis represents the value of a parameter and the horizontal axis represents time. In the case of audio synthesis, the instantaneous value of the parameter defines an acoustic specification of the instantaneous output of the audio synthesiser. (In practice, several parameters may are required to control the totality of the speech synthesiser's output.) In the case of video synthesis, the parameter specifies the instantaneous representation of one aspect of the video image generated.

The line on the graph represents the transition between a first value at V₀ towards a target value V₁, and then to a value V₂. In this example, there is insufficient time between t=0 and t=1 for the parameter to attain the target value V₁ within the limitations defined by the physiological model of the vocal system. It must be remembered that a change in the value of a parameter represents an instantaneous change in the output of an audio or a video synthesiser. A human speaker cannot change the configuration of their vocal system instantaneously, so speech produced by a human in many cases cannot change the sound that it produces instantaneously. For this reason, the application of HMS principles limits the rate of change of the parameter as it follows a track between one value and another. In some cases, typically where speech is rapid, the vocal system might not have sufficient time to reach a target configuration before the vocal system must prepare for to produce following sound. The result is that the vocal system will head towards the target, but not actually hit the target, as shown in the curved parameter track between t₀ and t₁.

As will be familiar to those knowledgeable of the technical field, the HMS system defines the parameter track between an initial and a final value as an interpolation between the two parameter values, restricted by left and right inner and outer boundary values, fixed contribution values and fixed contribution proportions. The system allows the starting value and the target value to be assigned a priority, the value of higher priority dominating the transition. Moreover, the HMS system takes into account the possibility that there is insufficient time to achieve a target value, if the physical system would have insufficient time to reach the target configuration due to its physical limitations.

This embodiment of the invention provides a so-called “talking head”; a system that synthesises human speech, generates an image representing a human head, and animates the head to give the appearance that the speech is being uttered by the head, for use, for example, to generate a virtual television presenter.

The system is embodied within software executing on suitable computer hardware. The software is configured to receive a stream of segment descriptors that describe a body of speech, process that stream, and generate a further output stream to drive a speech synthesis engine and a video synthesis engine. The parameters used in this embodiment are shown in Table 1. It should be understood that there are many possible alternative coding schemes that could be used in other embodiments of the invention. The segments used in this embodiment are the JSRC basic segment set to encode the forty-four phones of spoken English in between one and three segments for each phone.

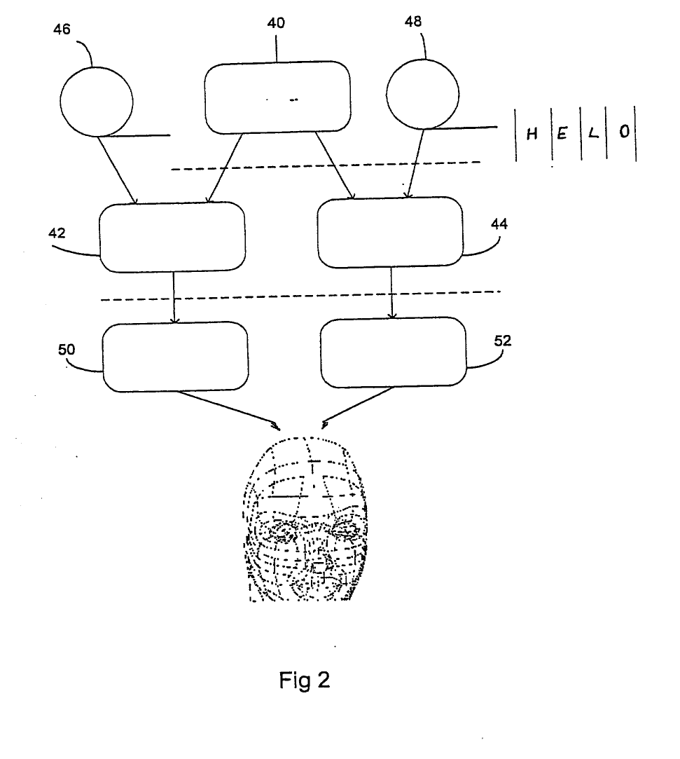

With reference to FIG. 2, the system includes a segment source 40 that generates a stream of segment descriptors using IPA coding, as described above. Such a source is a can be constructed in well-known ways by those skilled in the technical field, and so will not be described further.

The segment source 40 supplies data to an audio parameter generator 42 and a video parameter generator 44. The audio parameter generator 42 also refers to an audio parameter translation table 46 and the video parameter generator 44 refers to a video parameter translation table 48. Each parameter translation table 46, 48 defines parameter tracks between successive parameter values.

The output parameter tracks from each of the parameter generators 42, 44 are fed to respective audio and video synthesis engines. These generate, respectively, an audio and a video output defined by the instantaneous value of the parameters that they are fed. Thus, as the parameters change with time along parameter tracks defined by the parameter generators, so the audio and the video outputs change with time to generate a synthesised audio and video output. It should be understood that the embodiment allows synthesis of the video and audio outputs to take place in parallel.

The audio parameter translation table 46 implements parameter transitions in accordance with the HMS rules to generate acceptable-sounding synthesised speech. The video parameter translation table 48 generates parameter tracks that describe movement of the facial features in a display that represents a human face.

The parameter tracks are fed to an audio engine 50 and to a video engine 52. These may, for example, be audio and video components of an animation software package executing on a standard computer. Typically, for final reproduction, the video engine 52 generates a solid 3-D rendered image that is defined by the positions of a plurality of vertices.

In this embodiment, the image generated by the video engine 52 is entirely synthetic. That is to say, it is an essentially mathematical entity defined within a computer; it is not derived by processing images captured from an external source, such as a video camera.

In accordance with the HMS principles, each translation table includes, for each segment descriptor, a list of target parameter values plus a description of the track that each parameter should follow in order to attain (or move towards) the target. Moreover, as is known from HMS in audio synthesis applications, each segment as defined by the segment descriptors has a rank. At any segment boundary, the segment with the higher rank dictates the nature of the transition at the boundary. In the event that two segments have the same rank, the earlier (left) is chosen to be dominant.

At a boundary, where a segment to the right dominates over a segment to the left, the internal and external durations are defined by the left internal and external durations of the right segment. The parameter track is more likely to actually achieve the dominant value than the non-dominant value. The value of the parameter at the boundary is equal to the fixed contribution of the right segment plus the left fixed proportion times the target of the left segment. (If the left segment dominates, the roles of the left and right segments are reversed in this calculation.)

It should be noted that corresponding segments may be assigned different ranks for the purpose of audio and of video processing.

Computation of the parameter tracks proceeds as follows. Transitions from both boundaries of a segment are calculated. These will both be calculated, as described above. From there, the track will move towards the target value for that segment to reach it at the specified duration (specified by the dominant segment) within the boundary. The resultant parameter track, specifying the value of the parameter at time t for 0≦t≦1 is calculated by the following formula:

trackᵣₑₛᵤₗₜ(t)=(1−t).track_{left}(t)+t.track_{right}(t) (1)

This results in the parameter track shown in FIG. 1.

This embodiment specifies a total of seven parameters to define the features of an image that represents a human face. These are set forth in Table 1, below. Each parameter can take a value of between 0 and 1.0 represents an associated feature in a relaxed position while 1 represents the feature in a fully deflected condition, and an intermediate value represents a linear interpolation between the extremes.

TABLE 1

| Parameter | Explanation |
|---|---|
| Jaw opening | 0 represents the jaw closed (effectively with upper |
| | and lower teeth touching. 1 represents the jaw opened |
| | to the maximum extent normal during speech. |
| Lip rounding | 0 represents the lips straight. 1 represents the lips |
| | rounded to make a “oo” sound. |
| Lips closed | 0 represents the lips closed and relaxed 1 represents |
| | them tightly closed as when sounding the letter |
| | “m” or just before the lips part when |
| | sounding the letter “b”. |
| Raise upper lip | 0 represents the upper lip covering the upper teeth |
| | while 1 has the upper teeth exposed |
| Raise lip corners | 0 represents the lips generally straight while 1 |
| | has their ends raised, as happens in a smile |
| Tongue position | 0 represents the tongue touching the upper teeth |
| | and 1 represents the tongue below the bottom teeth |
| Lip widening | 0 represents the lip corners in a normal position |
| | and 1 represents the lip corners stretched laterally. |

The list of parameters presented in Table 1 is not intended to be exhaustive, and it may be that not all will be necessary in some embodiments.

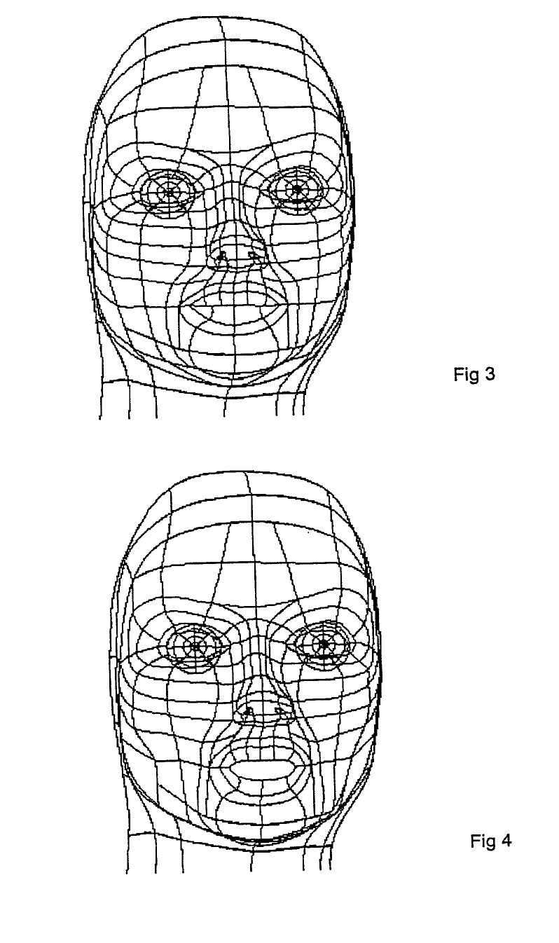

With reference to FIGS. 3 and 4, the effect of varying one parameter, in this case, jaw opening, is shown. FIG. 3 is an image that represents the video output when the value of the jaw opening parameter is 0 and FIG. 3 is an image that represents the video output when the value of the jaw opening parameter is 1. In the case of intermediate values of the parameter, the position of each vertex in the image is calculated as a linear interpolation between the two extreme values.

In most cases, the position of a point will be affected by variations in more than one parameter. In order that the influence of all parameters is reflected in the final image, a summing process is carried out. The position of each vertex that is controlled by parameters w₁ to wₙ is as follows:

$$V = {V}_{0} {\sum }_{f = 1}^{N} {V}_{f} - {V}_{0} ) \cdot {w}_{f}$$

Where V₀ is the neutral position of the vertex; w_{f} are the parameters where 0≦w_{f}<1; and V_{f} are the extreme vertex positions in the extreme position where w_{f}=1.

The video engine 52 repeatedly generates images having their vertices positioned according to the above formula as the parameters vary in accordance with the calculated parameter tracks. This gives the impression to a viewer of a continually moving image which is, in appropriate cases, rendered as a solid 3-dimensional image. By suitable selection of the data in the translation tables, this can give a lifelike appearance, taking into account the physical and physiological limitations of the human face, or can give an appearance that has another desired (and possibly not lifelike) appearance.

While the system described above is sufficient to provide an audio and video output, it can potentially give rise to representations of, for example, a human face in a configuration that a human could not adopt. This arises from the way in which the various parameters interact with one another. For example, as a human opens his or her jaw, their lips are stretched. This limits the extent to which it is possible for them to widen their lips. In other words, one can widen ones lips further when one's jaw is closed than when it is open. In the context of this invention, when the jaw opening parameter has a large value approaching 1, a more lifelike image may be attained if the maximum value of the widening parameter is restricted to a value less than 1. The entire set of parameters may be thought of as defining a parameter space that has permitted regions that define allowable combinations of parameters and forbidden regions that define combinations of parameters that should not be allowed to co-exist if the image is to remain lifelike (or if it is to meet some other criteria).

In this embodiment, this potential problem is addressed by careful selection of the values of the parameters given in the video parameter translation table 48. The range and combination of the parameters is selected to ensure that undesirable images are not produced.

In an alternative configuration of the invention, the video parameter generator includes a parameter modification stage that includes a definition of the entire parameter space divided into permitted and forbidden regions. As each set of parameter data is generated from the parameter track as time proceeds from t=0 to t=1, it is passed to the parameter modification stage. If the parameter data set is within a permitted region, it is passed to the video engine unchanged. If it is within a forbidden region, then the value of one or more of the parameters is adjusted until the data set is within the boundary of a permitted region. As a further alternative, a rule-based approach may be followed. For example, it may be specified that when a first parameter exceeds a threshold value, another parameter is limited to a value below a pre-determined maximum.

In addition to simulating movement of facial features, in alternative embodiments, it may be desirable to control other aspects of the image. This can be achieved in various ways. For example, an embodiment of the invention may include one or more additional sources of segment descriptors that are translated into additional parameters. For example, there may be segments to define head movements, eye blinking, head tilting, and so forth. These additional segment descriptors and parameters are typically processed in a manner similar to the video processing described above.

In such embodiments, there is typically provided an additional source of segment descriptors, a further transition table, and suitable additional processing capacity within the video engine 52.

What is claimed is:

1. A method of synthesising a moving image in which a configuration of a feature in an image is defined by one or more parameters and the progress of transition of one value of a parameter to another is controlled by one or more predefined rules, in which the value of each parameter defines the instantaneous position of a particular physical entity represented in the synthesised image.

2. A method according to claim 1 configured to produce a visual display that can exhibit movement with characteristics that are in accordance with a predefined model.

3. A method according to claim 2 in which the model is designed to approximate human physiology.

4. A method of synthesising a moving image in which a configuration of a feature in an image is defined by one or more parameters and the progress of transition of one value of a parameter to another is controlled by one or more predefined rules, in which the value of each parameter defines the instantaneous position of a particular physical entity represented in the synthesised image, in which translation of a segment into parameters includes generation of a parameter track that defines the change of a parameter with time

5. A method according to claim 4 in which the parameter track is at least partially determined by characteristics of the physical entity corresponding to the parameter.

6. A method for synchronising a display that will be associated with synthesised audio output in which a configuration of a feature in an image is defined by one or more parameters and the progress of transition of one value of a parameter to another is controlled by one or more predefined rules, in which the value of each parameter defines the instantaneous position of a particular physical entity represented in the synthesised image.

7. A method according to claim 6 for generating a visual display that changes in synchronism with synthesised vocal output to give an impression that the vocal output is being produced by an object illustrated in the display.

8. A method according to claim 6 in which the vocal output includes speech.

9. A method according to any one of claims 6 in which the vocal output includes song and/or other vocal utterances.

10. A method for synchronising an image representative of a human head and simulated human vocal output in which a configuration of a feature in an image is defined by one or more parameters and the progress of transition of one value of a parameter to another is controlled by one or more predefined rules, in which the value of each parameter defines the instantaneous position of a particular physical entity represented in the synthesised image.

11. A method according to claim 10 in which the value of each parameter defines the position of a corresponding physical feature represented in the displayed image.

12. A method according to claim 10 in which a first set of segments is processed to generate facial movements arising from speech and a further set of segments is processed to generate other facial movements.

13. A method of synthesising a moving anthropomorphic image in which a configuration of a feature in an image is defined by one or more parameters and the progress of transition of one value of a parameter to another is controlled by one or more predefined rules, in which the value of each parameter defines the instantaneous position of a particular physical entity represented in the synthesised image.

14. A method of synthesising a moving image in which a configuration of a feature in an image is defined by one or more parameters and the progress of transition of one value of a parameter to another is controlled by one or more predefined rules, in which the value of each parameter defines the instantaneous position of a particular physical entity represented in the synthesised image, in which the method employs a set of data to define synthesised audio signals and a set of data to define synthesised video signals.

15. A method according to claim 14 which includes a respective data set for each of the audio and the video signals

16. A method according to claim 15 in which the audio and the video signals are defined by a common data set.

17. A method according to any one of claims 14 in which the data set defines a sequence of segment descriptors.

18. A method according to claim 17 in which one or more such segments defines each vocal phone in the synthesised speech or a position of a visual element in a video signal.

19. A method of synthesising a moving image in which a configuration of a feature in an image is defined by one or more parameters and the progress of transition of one value of a parameter to another is controlled by one or more predefined rules, in which the value of each parameter defines the instantaneous position of a particular physical entity represented in the synthesised image, in which the method includes a step of translating segment descriptors into parameters that define an audio output and a step of translating segment descriptors into parameters that define a video output.

20. A method according to claim 19 in which each translating step includes a definition of the change of one parameter value to another.

21. A method according to claim 19 in which the step of translating the segments to generate the audio output proceeds in accordance with HMS rules.

22. A method according to claim 19 in which each of the video and the audio output is represented by a plurality of parameters.

23. A method of synthesising a moving image in which a configuration of a feature in an image is defined by one or more parameters and the progress of transition of one value of a parameter to another is controlled by one or more predefined rules, in which the value of each parameter defines the instantaneous position of a particular physical entity represented in the synthesised image, and the method includes a further step of rendering an image as defined by the parameters.

24. A method according to claim 23 in which the image is rendered as a solid 3-D image.

25. A method according to claim 23 which includes rendering a plurality of images from a stream of segment descriptors extending over a time extent, and displaying the plurality of images in succession to create an animated display.

26. A method according to claim 25 in which an audio output is generated in synchronism with the animated display.

27. A method according to claim 26 in which the audio output includes synthesised vocalisation.

28. A method according to claim 27 in which the synthesised vocalisation is derived from the stream of segment descriptors.

29. A method of synthesising a moving image in which a configuration of a feature in an image is defined by one or more parameters and the progress of transition of one value of a parameter to another is controlled by one or more predefined rules, in which the value of each parameter defines the instantaneous position of a particular physical entity represented in the synthesised image, in which method each parameter has a minimal and a maximal value that define respective first and second extreme positions for vertices in the said feature in an image.

30. A method according to claim 29 in which, in response to parameter values intermediate the minimal and maximal values, an image is generated with vertices in positions intermediate the first and second extreme positions.

31. A method according to claim 30 in which the vertices are in positions calculated by linear interpolation based upon the value of the parameter.

32. A method according to claim 29 in which the minimal value is 0 and the maximal value is 1.

33. A video image synthesis system comprising:
a. an input stage for receiving a stream of data that defines a sequence of segment descriptors,
b. a first translation stage for translating the segment descriptors into a plurality of parameter tracks for controlling a video output and
c. a plurality of parameter tracks for controlling an audio output.

34. A system according to claim 33 further including display means for receiving parameters and generating a display defined by the parameters.

35. A system according to claim 34 in which the display means generates the display according to rules as a function of the parameters.

36. A system according to claim 33 in which the display means generates a display that is synthetic and is not derived from a captured video image.

37. A system according to any one of claims 33 in which the display means is operative to generate an animated display in response to changes in the parameters with time.

38. A video image synthesis system comprising:
a. an input stage for receiving a stream of data that defines a sequence of segment descriptors,
b. a first translation stage for translating the segment descriptors into a plurality of parameter tracks for controlling a video output,
c. a plurality of parameter tracks for controlling an audio output, and
d. audio reproduction means for receiving parameters and generating an audio output defined by the parameters.

39. A system according to claim 38 in which the audio reproduction means is operative to generate what may be perceived as a continuous audio output in response to changes in the parameters with time.

40. A video image synthesis system comprising:
a. an input stage for receiving a stream of data that defines a sequence of segment descriptors,
b. a first translation stage for translating the segment descriptors into a plurality of parameter tracks for controlling a video output,
c. a plurality of parameter tracks for controlling an audio output, and
d. an audio-visual reproduction stage operative to receive a plurality of time-varying parameters and to generate an animated video display and a continuous audio output defined by the received parameters.

41. A system according to claim 40 in which each translation stage includes a translation table and is operative to generate a parameter track by reference to the translation table.

42. A system according to claim 42 in which the translation table includes a target value for each parameter to be achieved for each descriptor segment.

43. A system according to claim 43 in which each of the translation table includes a rank for each segment descriptor.

44. A system according to claim 44 in which, at a transition between two segments, the segment that has a higher rank predominates in defining the track followed by parameters during the transition between the segments.
